(19) United States
(12) Patent Application Publication
(10) Pub. No.: US 2013/0085925 A1
(43) Pub. Date: Apr. 4, 2013

(54) AUDIT AND VERIFICATION SYSTEM AND METHOD

(71) Applicant: IMARC, Santa Ana, CA (US)

(72) Inventor: Robert Simpson, Santa Ana, CA (US)

(73) Assignee: IMARC, Santa Ana, CA (US)

(21) Appl. No.: 13/632,900

(22) Filed: Oct. 1, 2012

Related U.S. Application Data
(60) Provisional application No. 61/541,006, filed on Sep. 29, 2011.

(51) Int. Cl. G06Q 40/02

(52) U.S. Cl. 705/38

(57) ABSTRACT

A system and method is provided for use by verification authorities to audit, review and verify information received by applicants or individuals. It allows the end user to verify the information received and return the verified information to whatever institution requires the verification and audit of the information received. The system and method provides full and complete reports and details to allow them to make crucial decisions on verifying the information received. Further, the system and method verifies information received from individuals that may be used such as background, employment and other types of information. The system may allow a user to verify income re-verification, asset verification and in-depth fraud analysis. The system may also provide update and current information on clients and can give an indication and/or predictors on loan defaults and potential problems and return that information to the institution requiring such information.

### CROSS REFERENCE TO RELATED APPLICATION

This application claims priority to U.S. Provisional Application No. 61/541,006 filed on Sep. 29, 2011, which is incorporated herein by reference in its entirety.

### FIELD OF THE INVENTION

The field of the invention is for a system and method for auditing a loan. More specifically, the field of invention is for a system and method that allows for the use of proprietary programming to audit and analyze loan information.

### BACKGROUND

Historically, throughout time, people have loaned valuables to others or have bartered articles of value for things like gold, silver and the like. The concept of giving an individual credit or loans has evolved and dates back thousands of years. These early lenders gave money that was paid back with interest to the lender. Typically, the lender who loaned money or another valuable item would take some article from the borrower in exchange for loaning the money. This way, the lender had something of value that they could sell or use if the borrower defaulted on the loan given. This type of secured transaction has evolved over time to allow lenders to have some interest or collateral in something when they lend money to others. To keep the transactions fair, over time, societies have enacted laws to impose requirements on lenders to keep the transactions orderly and less egregious. Many such laws now exist that seek to protect the borrower from egregious lenders and to establish a standard for lenders and borrowers. For example, there are many laws that regulate the lending of money to individuals, for example, to purchase a home. These laws provide standards and limits on costs associated with obtaining funds to purchase a property. Many of these laws inform both borrowers and lenders on requirements and limits on transactions in any jurisdiction. Additionally, in order to keep the practice of lending and borrowing civil, these laws provide regulatory oversight on what documents and information may be collected to determine an individual person's credit worthiness and their ability to pay back any loan.

In any real estate purchase and lending of money in a real estate purchase, there are clearly defined regulations for how the transaction must take place for a lender to provide funding to a purchaser of the real estate. For example, the timing of documents and disclosures that must be made to the purchaser are all spelled out by regulation and the lender must follow each of these regulatory requirements in order to lend money to a purchaser. Additionally, the amount of money that a lender can charge for a transaction relating to the loaning of money for the purchase of property is also limited by regulation. Still further, there are requirements on what information the lender may be privy to in determining credit worthiness and how much credit and/or loan money will be extended to each individual purchaser or borrower. Even the penalties for not following the regulations are spelled out in our laws to help keep the transactions orderly and organized. It also helps to keep fraudulent activity away from the business transactions.

However, because of the plethora of regulations that are set up to help regulate and coordinate business transactions, including the purchase of property, the lending requirements tend to be complex and sometimes very cumbersome. The amount of paperwork and documents that are necessary to process a loan for a real estate purchase can be voluminous. Further, it requires that all the paperwork and documents be properly filled out, verified and often times, notarized. The complexity and volume of documents have required that in order to verify a business's compliance and the purchaser's thoroughness by submission of these documents, that it requires tedious manual operation involving a person looking through all of the data in a loan file and trying to find and identify any violations. Because of the large amount of time it takes to review any particular loan file for compliance, it became common practice to not verify and check every loan that was submitted for loan processing. What became commonplace is that only a small sample of loan documents were reviewed and verified. Not only is this process subject to the hit or miss proposition of sampling, it is also subject to varying degrees of individual understanding biases in interpretation. Because the requirements are complex and interrelated, errors in the audit process occurred regularly. Additionally, another problem that exists is that because verification was not undertaken, many applicants for loans were being approved for loans they could not possibly afford to pay back, which in turn became a direct correlation with additional foreclosures and the need to call in the secured transaction. The entire process was inefficient, time consuming, subject to errors, non-standardized and also subject to the problems of un-reviewed documents and verification of the same.

Therefore, a need exists for an improved system and method for auditing and verifying information. Moreover, a need also exists for an improved system and method for auditing, reviewing and verifying information including loan documents, loan files, re-verification of assets, deposits and supporting documentation. Additionally, a need exists for an improved system and method for verifying every piece of information submitted by an individual applicant and doing so in an efficient, timely manner to allow for compiling of information for analysis by the end user.

### SUMMARY OF THE INVENTION

The present invention describes a system and method for use by verification of authorities to audit, review and verify information received by applicants or individuals, such as those that have applied for loans, new jobs and the like. It allows the end user to verify the information received and return that verified information to whatever institution requires the verification and audit of the information received. The present invention utilizes a proprietary software system and method which allows a institution, government agency, individuals and the like to get full and complete reports and details on clients to allow them to make crucial decisions on verifying the information received. Further, the present invention provides a system and method for verifying information received from individuals that may be utilized such as background, employment and other types of information. The system may allow a user to verify income re-verification, asset verification and in-depth fraud analysis. The system may also provide update and current information on clients and can give an indication and/or predictors on loan defaults and potential problems and return that information to the institution requiring such information.

Among the many different possibilities contemplated, the system and method may be utilized by financial institutions to audit existing loans.

In an exemplary embodiment, a system for verifying information, the system comprising: software to collect information relating to an individual; a database to store information pertaining to the individual; re-verifying pertinent information; and creating a written report of information contained in original documents and information collected by re-verifying pertinent information.

Additionally, in an exemplary embodiment, the system and method may be utilized by financial institutions to audit problematic loans.

Still another exemplary embodiment is to provide a system and method to verify information provided by the individual.

Another exemplary embodiment is to provide a system and method to audit, review and verify information received from an individual and return that information to the end user such as a financial institution, government agency, employment department and the like.

In yet another exemplary embodiment, it is contemplated that the system and method may be utilized to prioritize documents received during a financial transaction, job application or other verification process and access to those prioritized documents easier.

In another exemplary embodiment, it is contemplated that the system and method may be provided whereby the system may utilize a proprietary software system that may conduct fraud audits on both individuals and on portfolios held by financial institutions.

Another exemplary embodiment is that the system and method may provide information needed by the financial institutions to make executive decisions and may be utilized to identify red flags within documents obtained for a particular individual.

In another exemplary embodiment a system and method may be provided whereby the system may conduct research to be sure that employment information was not altered or misrepresented and verifies employment.

Still another exemplary embodiment of the present invention is to provide a system and method for verifying information whereby the system sends out a verification of employment (VOE) request form, along with any other documents that the system verifies, including Federal W-2 wage statements and paystubs. By returning the VOE, the employer lets the system know exactly what information can be verified.

Yet another exemplary embodiment of the present invention is to provide a system and method for verifying information whereby the system sends out authorizations that specify that the individual user has authorized the system to verify information contained in their file.

Another exemplary embodiment is that a system and method is provided to verify information whereby the system attempts to ensure that individuals were treated fairly during the process and that their information was accurately represented to the institution requesting the information.

A further exemplary embodiment is that a system and method is provided to verify information whereby the system attempts to ensure that individuals are treated fairly during the process and that their information was accurately represented to the end user/institution thereby the system contacts the individual to collect information relating to verification. This information may include assets, employment, credit worthiness, situational information, and the like.

Further, a contemplated embodiment of the system and method is to provide a verification system whereby the system may contact the individual to conduct an interview with the individual to collect information relating to the transaction and to verify that information contained within the documents are accurate.

Additionally, in an exemplary embodiment, a system and method is provided to verify a loan and/or loan portfolio, whereby the system conducts an investigation and analysis of loan files to determine if there were any first-party fraud, or loans in which the loan officer was aware that the borrower was less than qualified but made the loan anyway.

In yet another exemplary embodiment, it is contemplated that the system and method is provided to verify information whereby the system may minimize the possibility of dissemination of non-public information.

In another exemplary embodiment, it is contemplated that the system and method may be provided to verify information whereby the system reviews files and analyzes them for any form of misrepresentation or falsification.

Another exemplary embodiment of the present invention is to provide a system and method for verifying information whereby a system is provided that compiles information from the original documents, categorizes the documents, sorts the documents, seeks to verify information within each document and provide an analysis of red-flags or other potential problems with any existing individual.

Still another exemplary embodiment of the present invention is to provide a system and method for verifying information whereby the system works with mortgage insurers to audit loan packages, verify information and identify any areas of concern. The system may work through each file, re-verifying representations about employment, income, assets, and liabilities.

Yet another exemplary embodiment of the present invention is to provide a system and method for verifying information whereby the system presents its findings in a well-analyzed report which can provide the institutions with the facts and verification information needed to make decisions relating to a particular individual.

In another exemplary embodiment of the present invention, a system and method for verifying information is provided, whereby the system may customize each audit and verification report to fit the need of a particular institution including criteria that each institution may find more relevant than other verified information.

Still another exemplary embodiment of the present invention is to provide a system and method for verifying information whereby the system may utilize any income re-verification; asset re-verification; HUD re-verification; research of undisclosed liabilities and in-depth fraud analysis information.

Another exemplary embodiment of the present invention is to provide a system and method for verifying information whereby the system utilizes proprietary software and stores all information relating to the individual and verification in one place to make accessibility to that information specific to a institution and minimizes the possibility of dissemination of private information to un-intended third parties.

Yet another exemplary embodiment of the present invention is to provide a system and method for verifying information whereby the system may collect information for each individual including a complete review of the original file for which the verification process is started.

Still another exemplary embodiment of the present invention is to provide a system and method for verifying information whereby the system may collect information, review and validate employment and income information for an individual.

Another exemplary embodiment of the present invention is to provide a system and method for verifying information whereby the system may compile information and re-verify deposits and assets of an individual.

In yet another exemplary embodiment of the present invention is to provide a system and method for verifying information whereby the system may research public, online information and records to verify information relating to that individual.

Yet another exemplary embodiment of the present invention is to provide a system and method for verifying information relating to an individual or company whereby the system may create a written report regarding a particular individual/company with supporting documentation relating to the compiled and collected information and may bring attention to any red-flag events that may warrant further review.

Still another exemplary embodiment of the present invention is to provide a system and method for verifying information whereby the system may identify a probability of problematic red-flags found during the verification process.

These and other aspects of the present invention will become apparent to those skilled in the art after a reading of the following description of the preferred embodiments in combination with the figures.

### DESCRIPTION OF THE DRAWINGS

FIG. 1 illustrates an exemplary overview of the audit and verification system accordingly to embodiments described herein;

FIG. 2 illustrates and exemplary system to implement one or more portions of the audit and verification method accordingly to embodiments described herein;

FIG. 3 illustrates an overview of an exemplary arrangement of application modules of the system according to embodiments described herein;

FIG. 4 illustrates an exemplary report as generated at the conclusion of embodiments of the audit and verification method as described herein;

FIG. 5 illustrates an exemplary audit and verification method according to embodiments of the invention for mortgage fraud investigations; and

FIG. 6 illustrates an exemplary flow chart for file assignment that may be conducted prior to the process as indicated in FIG. 5 or as a sub-process to one or more of the steps identified in FIG. 5.

### DETAILED DESCRIPTION OF EMBODIMENTS OF THE INVENTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

A system and method for auditing and verifying information to determine whether that information was falsified. Exemplary embodiments as provided herein are described in terms of reviewing loan files and analyzing them for any form of misrepresentation or falsification. However, the audit and verification process may be applicable to other industries where information is compiled, and the veracity of that information is desired. For example, embodiments may be used in the employment context to determine the veracity of a potential employee's employment record and stated application information. Embodiments as described herein may be used to determine why a loan went bad or to identify areas of concern prior to default. The audit and verification method may include re-verifying representations about employment, income, assets, and liability. The method may also permit the borrow and/or lender to rebut or contribute any information to make a complete determination about a loan application.

Mortgage insurance companies have a fiduciary responsibility to pay all valid claims, but they also have a duty to deny fraudulent claims. Embodiments as described herein may help insurance companies determine the veracity of a claim. Embodiments of the present audit and verification method may be applied to loan files to discover first-party fraud, or loans on which the loan officer was aware that the borrower was less than qualified but made the loan anyway. Embodiments as described herein also permit the efficient and timely handling of files to permit a determination on a high volume of files in a timely fashion.

An exemplary embodiment is described in which a company uses embodiments of the audit and verification method and system to determine the veracity of statements made during a loan application to determine identify potential bad applications or determine a cause for a delinquency. A client may therefore approach the company to make an independent audit and verification of a loan application. The client may be an insurance company requested to make a claim on a delinquent mortgage, or may be a lender seeking revalidation of its determination to lend to a borrower (i.e. applicant). Embodiments as described herein may be used in other situations and relationships. The company, client, applicant scenario is provided was merely provided as an exemplary application of the invention as described, and is not intended to be limiting in any way.

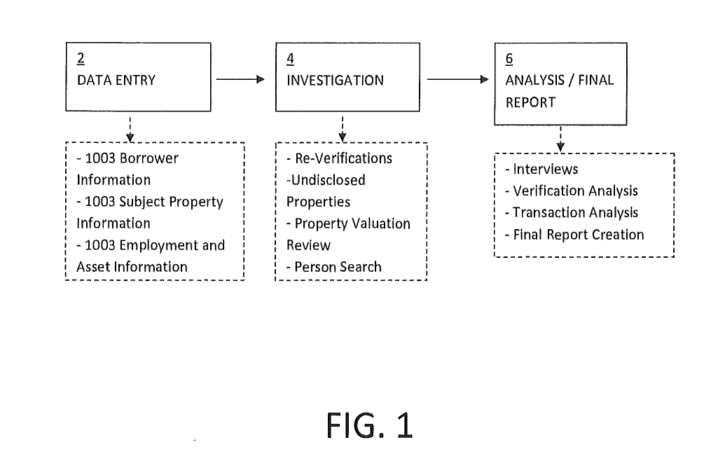

An exemplary overview of the audit and verification system is illustrated in FIG. 1. The method may include one or more of the described steps, in any combination and order. In general, the audit and verification method may be subdivided into three general categories: data entry 2, investigation 4, and analysis/final report 6.

First, data entry 2, the various information and data may be entered into embodiments of the system as described herein. For example, borrower information, information about the subject property, employment and asset information of the borrower may be entered into the system. The information may be obtained from the originally provided information submitted with the loan application. This information may be obtained directly from the borrower, and/or the loan agency. An independent agency may or may not have reviewed or verified the information supplied. Alternatively, the information may be obtained from the final loan processing information and include independently reviewed and verified information as it existed at the time of the loan application and approval. The information may come from other sources and may originate at different times of the process, such as at the application stage, when the loan is granted and proceeds dispersed, at default or any time before, during, or after any of these stages.

An investigation 4 may follow the data entry 2. The investigation process may include obtaining any information not supplied and entered in the data entry 2 stage. The investigation may also include a revalidation of the information supplied. Therefore, the investigation may include re-verifications of any information supplied and entered from the data entry 2 stage. An investigation may be performed to determine whether there exists any undisclosed properties or assets. The provided and found properties and assets may be independently valuated or revaluated to determine their present worth. A review of any prior valuation may be conducted to determine the propriety of the previous assessments. A person search may also be conducted to verify the identity of the application and find any related persons.

After all of the information is obtained, evaluated, and verified, an analysis 6 of the transaction may be performed. The borrower and/or lender may be contacted to permit any findings to be further verified, explained, corrected, or contradicted. This permits the borrower/applicant to refute any finding and/or present any further information not found in the investigation process. Personal interviews may be conducted with the lender, applicant, employers, friends, references, loan broker, and anyone else involved in the loan process with pertinent information. Interviews may be conducted if conflicting information arose during the investigation process that requires reconciliation. Interviews may be conducted to obtain any further information that is missing, inadequate or otherwise questionable. Finally, a verification analysis and transaction analysis may be performed. The verification analysis may identify potentially conflicting information relied on during the original loan application process. The transaction analysis may review the original loan application transaction to determine if any problems arose that were inadequately handled. Finally, a report may be created containing all of the data obtained and/or verified and the conclusions drawn therefrom.

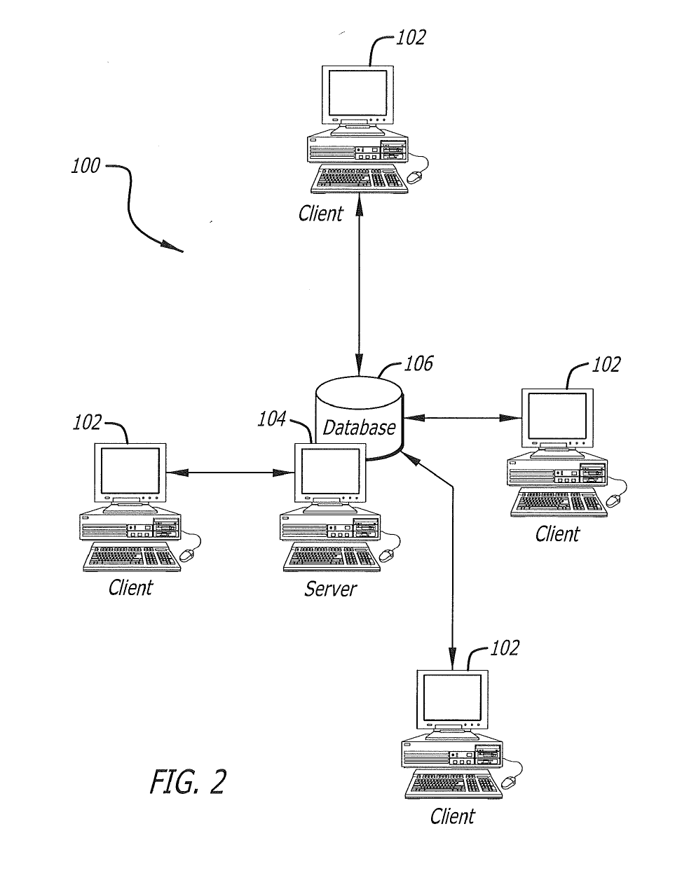

In one embodiment, a system may assist in performing the audit and verification method, as described herein. For example, FIG. 2 illustrates and exemplary system 100 to implement one or more portions of the audit and verification method. The system may use a client-server architecture to provide access by multiple users to one or more information depositories. One or more (exemplary four) clients 102 may be connected together over a server 104 to access one or more databases 106. The connection may be, for example, over a local area network (LAN) or over the internet.

As shown in FIG. 2, each client 102 may be a computer station, such as a desktop or laptop connected to the server 104. The client 102 may include a processor (not shown), memory, and input/output devices, such as a screen, keyboard, and/or mouse. The client also may include one or more network connections to connect to the server.

The server 104 may be a separate computer dedicated to supporting the network and database as described herein. The server 104 may alternatively provide direct access and be used similar to a client 102. The server includes one or more ports to couple to each client 102. The server may include memory for storing elements of the database as well as operating instructions to execute the one or more processes, modules, and computer readable instructions to perform the audit and verification method. The server may include one or more processors for executing the processes and modules to perform the described audit ad verification method. For example, the server 104 may be a special purpose computer programmed to perform the algorithms as disclosed herein. The database 106 may be stored in one or more memory locations within the server computer or may be retained in a separate memory location than the server. The database and server may not be geographically or physically close. For example, the database may be retained in a computer memory accessed over the internet from a geographically distant place.

In an exemplary embodiment, the system permits file processing. File processing logic is configured for generating and delivering reports from data stored within the database, and receiving, processing and cleaning up loan documents received into the system. The file processing logic is performed by processing logic that may comprise hardware (circuitry, dedicated logic, state machines, etc.), software (such as is run on a general purpose computer system or a dedicated machine), or a combination of both. For example, the system may define a process for acquiring monthly funded reports, delivery of the reports, and receipt/pre-processing/cleanup of loan documents from clients. The receipt of documents from clients may be paper files converted to PDF, may be in single PDF files, or may be in a zip file, for example. The system takes the information as imported, extracts the needed information, and properly saves the documents to the system. Therefore, the system provides a process for receiving, pre-processing, cleaning-up client information and inserting that information into the case file management system.

In an exemplary embodiment, the system permits quality control processing. Quality control processing logic is configured for originating and progressing a case file through the system for various audit and verification requests (e.g. pre-funding, post-closing, or delinquency). The quality control processing logic is performed by processing logic that may comprise hardware (circuitry, dedicated logic, state machines, etc.), software (such as is run on a general purpose computer system or a dedicated machine), or a combination of both. The process may include, but is not limited to: opening, coordination, analysis, and underwriting. The opening process may include data entry and document association from the loan documents. The coordination process may include integrity validation of data entry and document associations; send, receive, and clarify re-verifications; complete function checklists per stage and log findings. The analysis process may analyze and validate coordinator checklist findings; complete function checklist per stage and log findings. The underwriting process may include re-underwriting file an address discrepancies; complete function checklist per stage and log findings.

In an exemplary embodiment, the system permits third party processes. Third party processing logic is configured for providing an interface to permit third parties to receive and supply information to the audit and verification process and system. The third party processing logic is performed by processing logic that may comprise hardware (circuitry, dedicated logic, state machines, etc.), software (such as is run on a general purpose computer system or a dedicated machine), or a combination of both. For example, the system may define a manual and/or ETL (extract, transform, load) process for third party services. Exemplary third party processes include credit report request and acquisition; appraisal and/or AVM request and acquisition; 4506 request and acquisition; person searches; employment service requests and processing (e.g. WorkNumber); asset verification service request and processing (e.g. BankVOD). The third party processes may additionally define fee management and threshold monitoring to track charges and ensure that client-approved fee caps are not exceeded. The third party processes may also include a rebuttal process.

In an exemplary embodiment, the system permits a rebuttal process. Rebuttal processing logic is configured to permit a borrower/applicant, lender, insurance company, or the client to initiate a rebuttal to any findings of the audit and verification process, as well as set features and attributes of the rebuttal process. Rebuttal processing logic is performed by processing logic that may comprise hardware (circuitry, dedicated logic, state machines, etc.), software (such as is run on a general purpose computer system or a dedicated machine), or a combination of both. The system may define a process to outline the initiation of a rebuttal, the eligible rebuttal period and its duration, how escalations can and will be utilized, and what happens at the end of a rebuttal window for various scenarios (e.g. no rebuttal initiated, rebuttal initiated and accepted, rebuttal initiated and rejected, rebuttal initiated without acceptance or rejection (passive rejection). Before a quality control review is finalized, the client and/or applicant may be provided an opportunity to respond to the findings through a rebuttal process that is initiated when a finding or its severity is challenged by either the client or applicant. Once initiated, deliberation begins between the client/applicant and the company resulting in either a passive or active resolution. Deliberation between the company and client/applicant can commence via a web portal during the rebuttal period and through the negotiation window. The rebuttal process may control the web portal to provide an exchange interface between the company and the client and/or applicant. The web portal may provide the client/applicant an interface to post the reasons why they disagree with a finding or its classified severity. The web portal may also provide the client/applicant the ability to upload documents or other evidence as electronic files (e.g. PDFs) to support their position described in their post of reasons. The web portal may also provide an interface to permit a client/applicant to respond to additional statements/findings provided by the company in response to the initiate rebuttal. The client/applicant may navigate the web portal to a rebuttal being deliberated. The client may choose to post a response and may be provided a text box or other avenue to post their comments. Additional features, such as drop down boxes, selection buttons, etc. may provide preselected choices, such as to agree without dispute. The rebuttal process may set an initiated rebuttal to “complete” and tag the rebuttal appropriately when one of the following occurs: client/applicant accepts the findings as I and agrees to close it, tagging the rebuttal as “closed”; the company agrees with the client's/applicant's refute of finding or its severity and agrees to overturn it, tagging the rebuttal as “overturned”; neither client nor company agree on a resolution by the end of negotiation period, tagging the rebuttal “expired”. The rebuttal window may be set by a user through the rebuttal process. For example, the rebuttal window may be set at approximately 30 days from the start of a quality control review and upon delivery of the preliminary monthly loan review (MLR) report, a seven day period may commence and enable the client the opportunity to initiate rebuttals on any of the quality control review findings. A negotiation window may also be provided. For example, the negotiation window may be a 3 day period immediately following the rebuttal window that can be used to further deliberate rebuttals initiated during that period. The negotiation window provides extra time to resolve a rebuttal already initiated, but may be set to prevent further rebuttals from being initiated.

In an exemplary embodiment, the system may provide a report delivery process. Report delivery processing logic is configured to make and deliver reports to a client, including setting attributes and features to customize the reports available to a client. Report delivery processing logic is performed by processing logic that may comprise hardware (circuitry, dedicated logic, state machines, etc.), software (such as is run on a general purpose computer system or a dedicated machine), or a combination of both. The system may define a process for how and when reports will be delivered and/or made available to the client. The web portal may use XLT style sheets for the initial loan review (ILR) and MLR reports. Style sheets may be used to simplify dynamic reporting by segregating the layout from the data, which is also simplify the integration of web service API's.

Since multiple sources of data may be used to populate a loan file (e.g. 1003, credit report, income and asset documents, etc.) some sources may be given priority over others, such that the information from one source supersede another. In certain circumstances, the data may be flagged as containing a discrepancy whether a priority determination is made or not. Each data may also be tracked as either declared or verified. The quality control processes may be used to set these preferences to compare the data received from the file process. For example, loan information obtained from the original loan documents may be a declared source of a social security number while the credit report is a verified source of that same information. For example, if the name on a W2 has a different spelling or maybe a different middle initial than the loan documents or other supporting documentation, then a flag may be set to identify the discrepancy. A log of the alternative information as source for each alternative may also be maintained. The ILR may present this data in an easy to understand format for the client. The report delivery process may generate ILR report including all of the data found as well as an indication of whether it is declared or verified, its sources, and whether any discrepancies were present.

The MLR report may be a form summation of the data from the case file for a group of loans. The report delivery process may provide a fairly straightforward method to auto-generate the MLR report as long as the information is resident in the system. In a preferred embodiment the user interface and database will account for the insertion and storage of all data elements resident or aggregated in this report.

An Executive Summary may also be generated as a report to contain statistical information with areas of dynamically-generated content.

In an exemplary embodiment, the system may include billing and invoicing processes. Billing and invoicing process logic is configured to define how pre-funding, post-funding and delinquency reviews will be billed and invoiced for each file Q/C'ed as well as pass-through charges for third part services. Billing and invoicing processing logic is performed by processing logic that may comprise hardware (circuitry, dedicated logic, state machines, etc.), software (such as is run on a general purpose computer system or a dedicated machine), or a combination of both. Multiple billing and invoicing options may be available for client preferences.

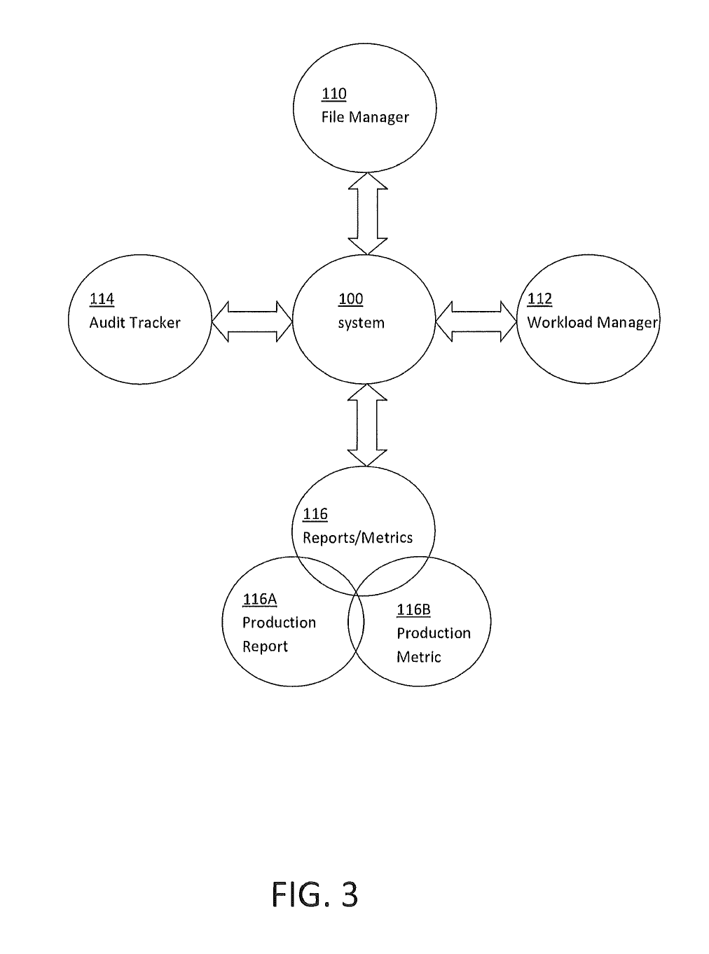

FIG. 3 illustrates an overview of an exemplary arrangement of application modules of the system 100. The system 100 may use one or more application modules to execute the audit and verification system as described herein. For example, application modules may include a file manager module 110, workload manager module 112, an audit tracker module 114, and reports/metrics module 116. These modules may be executed by the system to perform various functions of the audit and verification method.

In an exemplary embodiment, the file manager module may be one of the application modules. The file manager module 110 may be used to enter and access information and files created during the audit and verification method, described above. For example, the file manager may enable access to any and all files created by the audit and verification system. Files may include information obtained and entered during the data entry 2 stage described above. The file manager module may support advanced filters and searches to quickly and easily find a desired piece of information. The file manager module may include an interface to provide a user a way to set filters or perform a search to obtain desired information. The file manager module may include one or more export features to allow customized manipulation of data. The export feature may permit a user to extract desired fields from the database and present the information in a chart, grid, graph, or other format. The information may be extracted to various formats, such as a document or text file (e.g. .doc file), a spreadsheet (e.g. Excel), webpage (xml), and/or as an image (PDF, or JPEG). The file manager module can present the information to a user through a user interface. For example, a spreadsheet format may be used to present completed and pending cases undergoing the audit and verification process. Various information may be presented in the user interface, such as a due date and identification number. The presented information may be selected by a user. Each column of information may support sorting to prioritize cases, such as for example, by due date.

The file manager module may permit a user to open a new file within the system. The new file acquisition may include an automated script to open one or more files given a set of inputs from the user. The new file acquisition may be downloaded or packaged. The file manger module may present a user a single data entry screen to enter content and validation information. The user interface may include a set of entry boxes, drop down boxes, toggles, click boxes, etc. to enter in information obtained from the original loan application papers and from the validation process. The file manager module may also be used for third party data acquisition.

The application modules may also include a workload manager module 112. The workload manager module may permit various users to access one or more database pages without conflict by another user accessing the same page. Therefore, the workload manager module 112 may monitor work queue counts by function. Individual tabs may allow multiple users to work each queue without conflicts. Access may be controlled to each tab and governed by dynamic use and group permission systems. The workload manager module 112 may also switch between workload and file manager sections and watch files drop off lists automatically when removed from a pending list. The workload manager module 112 supports filtering by an analyst. The workload manager module may also present various information to a user through an interface. The interface may be presented in a spreadsheet column/row format with different tabs identifying desired information/formats. The list or spreadsheet information may be sorted to prioritize information, such as by due date or identification number.

The workload manager module may auto-generate verifications. Send/receive handshaking may be used to permit various users to access the system at a time and or manipulate the data at any given time.

The reports/metrics module 116 may implement a production reports module 116a and a production metrics module 116b. These modules may be implemented as separate modules, or combined into a single module.

The production reports module 116a may be used to generate one or more reports to track the pending and completed cases of the audit and verification method. The production reports module 116a may be used to analyze and generate the statistics associated with the pending and closed cases of the audit and verification method. For example, the production reports module may determine the number of files received from a client per month; the completed files by client per month, the average file completion lead time by client, the average company re-verification lead time, the average company report completion lead time. The data may also be determined under different parameters, such as per analyst or by analyst and function, instead or in addition to by client.

The production metrics module 116b may be used to track the output and quality of work. For example, the production metrics module 116b may be used to track the team and employee production output. Therefore, the number of files, the verification output and sent/back ratios, the report completion numbers, the borrower interviews conducted and attempted, the business searches completed may be tracked by analyst to determine an employee or teach production output. The production metrics module 116b permits the system to measure efficiencies quality of work, accuracy and attention to detail. The system therefore permits a grading by up-line team members.

The system also permits performance monitoring of production metrics. The system may track received versus completed files broken down by various time intervals (day/month/year/custom period) or by various option (client, loan type/lien position/combination). Turn-around times to compete files may be tracked for individual cases, clients, or provided as an average by client per time period (month/quarter/year) or by file type or lien position. The percentages of cases compete within a given number or span of days may be tracked. Efficiencies of the system, employees, teams, and company may be determined. For example the output per employee or money spend by employee may be monitored. Profit margins per time period (month/quarter/year) may be provided in real time to determine an effectiveness of an employee. Employee production may be monitored including the number of cases opened, reports generated searches performed, interviews attempted and/or competed, outputs generated.

The audit tracker module 114 may be used to track activity within the system and database. Therefore, the data entry additions, changes, and deletions may be tracked by the audit tracker module. By tracking this information, the audit tracker module may provide revision history for each case/file including the when, who, and what regarding each system and/or database modification. This information can be used to determine why an addition, modification, or deletion was made. The activity tracking permits a check and balance on the use of the system as well as user accountability.

The activity tracking permits proactive management of the audit and verification process. For example, the system permits real-time management of the files/cases that are in process. The file management module may order cases by priority, such as for example by due date. The cases may be additionally color coded to indicated cases as overdue, highlighted in red, close to due, highlighted in yellow if, for example, within 5 days of a due date, or those with sufficient time to a due date, highlighted in green. The workload management may be used as an accountability tool for the audit and verification company including its employees and analysts. For example, the number of files not opened with x days, verifications not out within x days, cases without follow-up within x hours, or interviews not attempted within x days may be tracked by employee/team or pending case in real time to determine whether a case is progressing efficiently.

The system may include a rebuttal module to facilitate tracking and communication management during the rebuttal process once a rebuttal has been initiated by the client during the eligible rebuttal period. The rebuttal module may provide different users different interface options or levels of functionality with the system depending on an assigned role. For example, some users may merely view the rebuttals while others can initiated and respond. The system may also include a rebuttal summary module that may allow a client to review rebuttals in reference to issues found as well as the result obtained.

The system may include other client modules, such as:

A message center module may be provided to facilitate intra-fie between internal company users (employees within the company, e.g. analysts) as well as intra-file and general communication between internal and external company users of the system. For example questions or comments about processes or service issues may be provided between the client and company users. In an exemplary embodiment, a dashboard may be provided to display a messaging list. The system may provide targeted messaging and well as reply to, reply to all, forward and delete messaging options.

An admin module may be provided to set client preferences. This module may provide a client with its own client use management. For example, the admin module may allow clients to create user accounts or their own uses in specific roles as well as to create accounts for their correspondents. For example, a client ABC may have 3 correspondent brokers and could create admin accounts for one or more individual users at each of these brokerage shops.

An upload module to enable upload of monthly funded report (implemented in, for example, CSV or XLSX) and loan documents (using, for example, PDF or TIFF) both individual o in batches (such as zip file).

A download module to permit file exports.

An activity Summary module to display the activity for one or more cases undergoing the audit and verification process.

A reports module may be provided with links to canned to reports with the ability to view defined aggregate data over user-specified ranges, such as date ranges, loan types, etc.

One or more modules or processes may be used to implement portions of the described system. Different modules, including the file manager, workload manager, production reports, production metrics, audit tracker, rebuttal, message center, admin, upload, download, activity summary, and reports are shown and described as separate modules to implement various aspects of the described method. The modules may be configured for the described function. Modules may be performed by processing logic that may comprise hardware (circuitry, dedicated logic, state machines, etc.), software (such as is run on a general purpose computer system or a dedicated machine), or a combination of both. The modules may be software applications executed by a processor and stored as computer instructions in a memory accessible by the processor. The modules may be portions of the web portal to provide various users access to the system to receive and submit information to the system. Different processes, including the file process, Q/C process, third party service process, rebuttal process report delivery process and billing and invoicing process, are described including sub-processes. These applications (processes and modules) may be combined, sub-divided, separated, deleted or reconfigured and remain within the scope of the present invention. The described system, including the specific processes and modules, are presented by way of example only and are not intended to limit the invention.

Embodiments as described herein are therefore available to permit an audit and verification process to be performed while tracking information to perform an assessment of the audit and verification process itself. Generally, the system may include a module for entering information. The information may include information obtained from the original loan documentation as well as information as obtained from the independent verification procedure. The information is entered into a database. The information may be exported, analyzed, or otherwise reviewed to determine the needs of the client, such as for example, to determine whether a fraud was part of the original loan process. The system may also include modules to track the efficiencies of the system, such as for tracking the number of files initiated/completed in a week, as well as the mean, medium, or average turn-around time. The system may also provide an indication of the total results obtained, such as how many cases concluded in finding fraud, finding no fraud, or were inconclusive. The productivity of analysts may be tracked to determine the number of cases handled, the number of interviews initiated and completed, as well as the number of hours worked. The system may use all of this information to rank employees/analysis to determine their efficiencies.

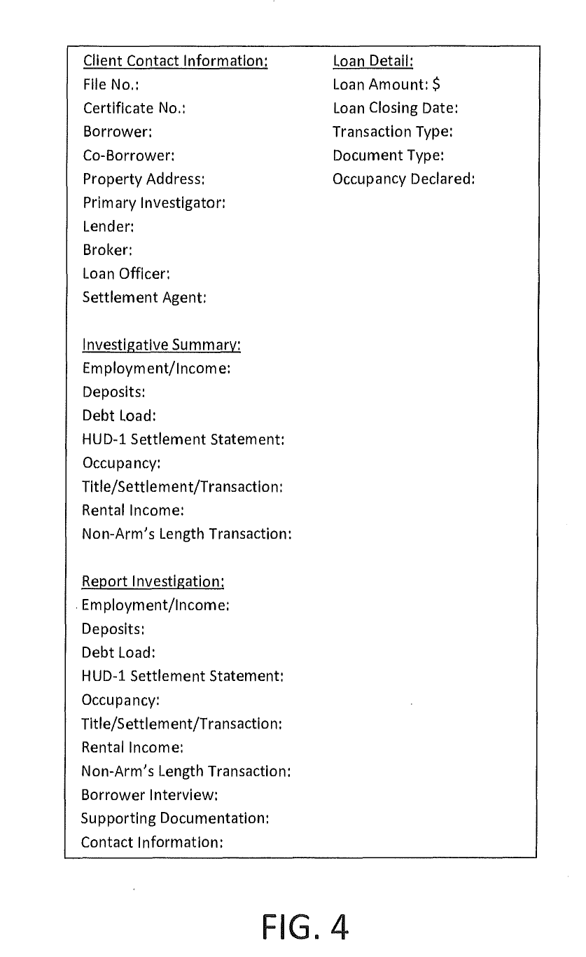

FIG. 4 illustrates an exemplary report as generated at the conclusion of embodiments of the audit and verification method as described herein. The report may include various details that mortgage insurance companies need to make crucial decisions, such as to pay a claim. The report may provide the information as presented in the loan application as well as re-verified, validated, and independently reviewed or obtained information to directly compare the veracity of the supplied information. Information may be obtained from employment documents, loan documents, as well as other sources. The report may also include information regarding independent result results of the parties affiliated with the transaction against known watch lists. The report may include one or more documents.

Review and reports may be provided to provide a pre-funding quality control review. The process may include an independent assessment of the loan application documents, such as a recalculation of the underwriting ratio, and qualifying income. Documents may also match documents and underwriting conditions to the AUS findings report. All document reviews, validations, and verifications are undertaken to assure the client that their loans at that point in time are compliant with all of the operational and investor requirements.

Review and reports may also be provided to provide post-funding quality control audits. The review and corresponding reports may be used by a mortgage company to comply with investor requirements by re-underwriting the file according to investor guidelines. Therefore, a report may be generated to re-underwrite the borrower credit, obligations, assets and income, and appraisal desk review. A report may include a conclusion whether all pre-funding steps were completed in accordance with the most recently published guidelines of the GSE or secondary market investors, including, but not limited to, evidence of borrower ID validation and no unexplained increases in liability. The report may also include a re-verification of the key documents that led to the lending decision and a result of a review that they met the lender's operational guidelines.

A review and corresponding report may also initiated and generated after a loan delinquency, such as at 30, 60, 90 or more days of delinquency to provide a standardized reason code for why the loan did not perform as expected. Evidence to support the decision may also be provided with the report. The report may conclude that the delinquency was a result of a life event, such as job loss, or was because the file contained a material misrepresentation. The review and report process may include verbal and written re-verifications of key documents, public record research, and retro valuation services that will ensure that the property was valued appropriately at funding.

Any combination of the review and report process according to embodiments as described herein may be combined to provide a custom audit to meet a specific need. Accordingly, it is contemplated that the procedure as described herein may be tailored to include different step, skip steps, combined steps, separate steps, or otherwise reconfigure the described method and still be within the scope of the present invention. For example, a reduced audit procedure may be followed to update a previously performed audit that includes only select processes as described herein.

For example, a report may include client contact information, loan detail information, investigative summary, and report investigation sections. The client contact information section may include an identification number for the audit and verification request, as well as identification of all the persons involved in the loan and/or audit and verification transactions. The report may also include loan details, such as the amount, closing date, transaction type (e.g. purchase, refinance), document types may also be included to indicate what was used during the initial loan process (e.g. no ratio, stated income and/or assets, verified income and/or assets), and occupancy/primary use of the purchased property (e.g. investment/rental, primary residence, secondary residence). The loan purpose may also be included, such as for a rate/term. The loan purpose may be included, for example, when a refinance was obtained to indicate the purpose of refinancing. The investigative summary may include the conclusions for various items of interest. For example, the report may provide whether the information was verified, the loan information during the application process was correct or misrepresented, or whether insufficient information/evidence was obtained to refute the findings. The report investigation section may include the detailed findings, facts, and investigation summary conducted to come to the conclusions detailed in the investigative summary section. For example, if a misrepresentation is identified in the summary section, the report investigation section may provide the data and source of the information originally supplied, data and source of any information conflicting with the original information, and additional investigation and sources reviewed to make the misrepresentation conclusion. Therefore, the report investigation section may include essentially the chronology of the investigative process leading to the conclusion given in the summary section.

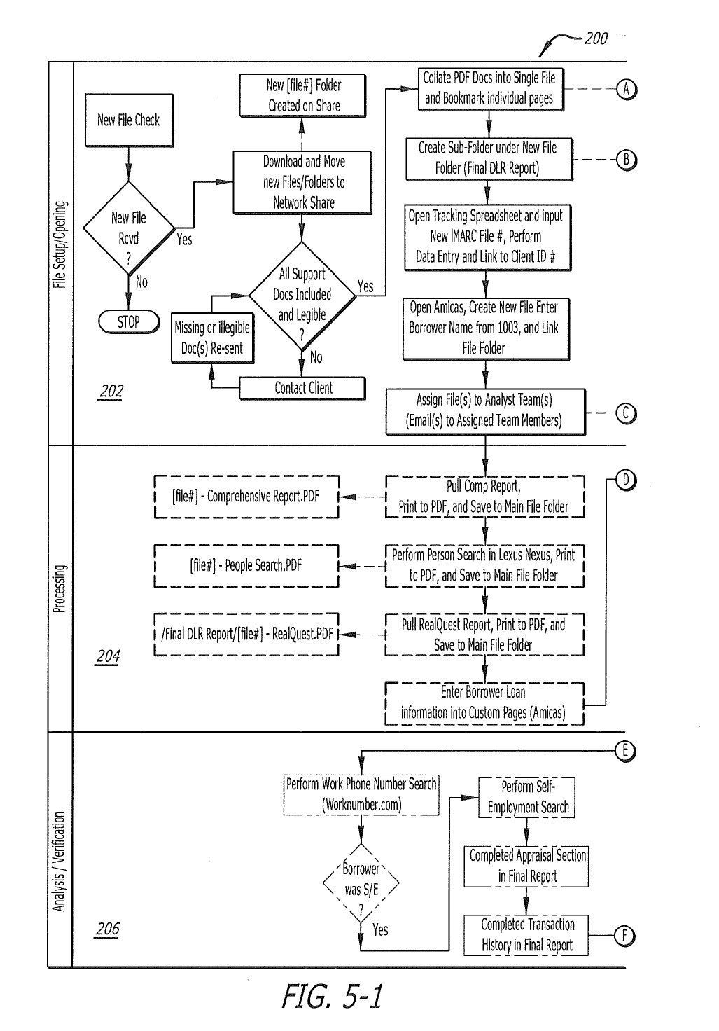

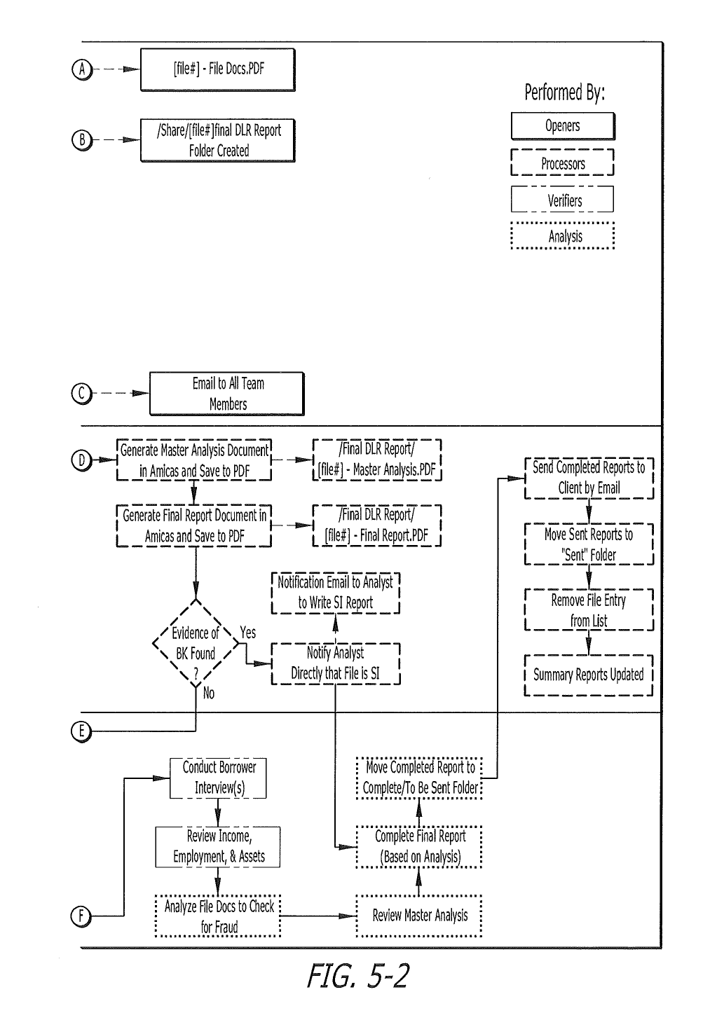

FIG. 5 illustrates an exemplary audit and verification method according to embodiments of the invention for mortgage fraud investigations are represented by the exemplary flowchart 200. The illustrated exemplary embodiment is divided into multiple sections. This lends itself to applications for a division of labor. However, each step may be re-sequenced, combined, separated, skipped, or otherwise modified as necessary for the particular result desired.

In a first section 202, the audit and verification method is initiated. A request for an audit is received (not shown) and the file setup and opening begins. Once a request for an audit/verification is received, all of the associated files and documents are compiled. Therefore, a new file check is performed to determine if all of the new files have been received. If they have not, then the method stops until the files are received. Requests for files may be repeated requested as necessary until the required files and documents are received. Once the documents are received, an electronic working file is created to provide access to the required documents by all people working on the audit and verification request. For example, a memory storage device or drive may be used and accessed over a shared network. A new folder may be created on the shared network drive and all of the received documents downloaded or saved to the shared directory. A review of the documents may be performed to ensure all of the required documents are present and legible. If the documents are incomplete illegible, or otherwise compromised, a new copy can be obtained from the lending company. Once all of the necessary documents are obtained and are in sufficiently legible and appropriate quality, the documents may be collected and collate. In an electronic format, the documents may all be put into a PDF format with individual documents bookmarked.

Once the files are in appropriate condition, the administrative tasks may begin. For example, the appropriate templates, documents, and folder holders may be generated in preparation for completion later in the process. The analyst team may also be assigned to the project. Once assigned, the analysts can be alerted, such as through email, that the audit and verification has been initiated.

Once the file setup and opening process 202 has been completed, the processing 204 may begin. Processing of the investigation may include pulling and recalculating and re-determining the various analysis that was performed for the initial loan application.

Finally, once the processing 204 has completed, the analysis and verification process 206 may commence. The analysis and verification process 206 may include various searches to verify the initial loan application data. Interviews, questionnaires, or other third party contacts may be initiated to obtain and verify information. As described herein, the system may provide an interface for sending and receiving information from third parties. Telephonic or in person interviews may also be conducted as necessary and the information entered into the system.

Embodiments as described herein may be implemented in an assembly-line fashion, so each department specializes in just one task. This method improves efficiency and drives down cost. As can be seen in FIG. 5, different tasks or sets of tasks may be assigned to one or more departments. For example, there may be operators, processors, verifiers, and analysts. The operators may perform administrative tasks, such as opening files, tracking papers (requests and responses), creating all of the support documentation templates, files and folders, and perform an initial file audit to determine if all the necessary documents are present and legible. Processor may review the information as compiled by the operators. For example, the processors may create or pull various reports from the provided information. They may perform the assessment of the original loan documents. Verifiers may perform any necessary verification of the submitted information. The verifiers may send and receive documents and questionnaires to various people and/or companies to verify the information supplied in the original documents as compiled by the operators. For example, questionnaires may be sent to previous and current employers to verify employment status, history, salary, and other pertinent information. Verbal interviews may also be held with the original loan application, references, or other people of relations to verify identity and other information. Finally, analysts may review and compare all of the obtained information to draw conclusions and create the final report. The conclusions and final report will depend on the audit performed (pre-funding quality control, post-funding quality control, after delinquency audit, etc.).

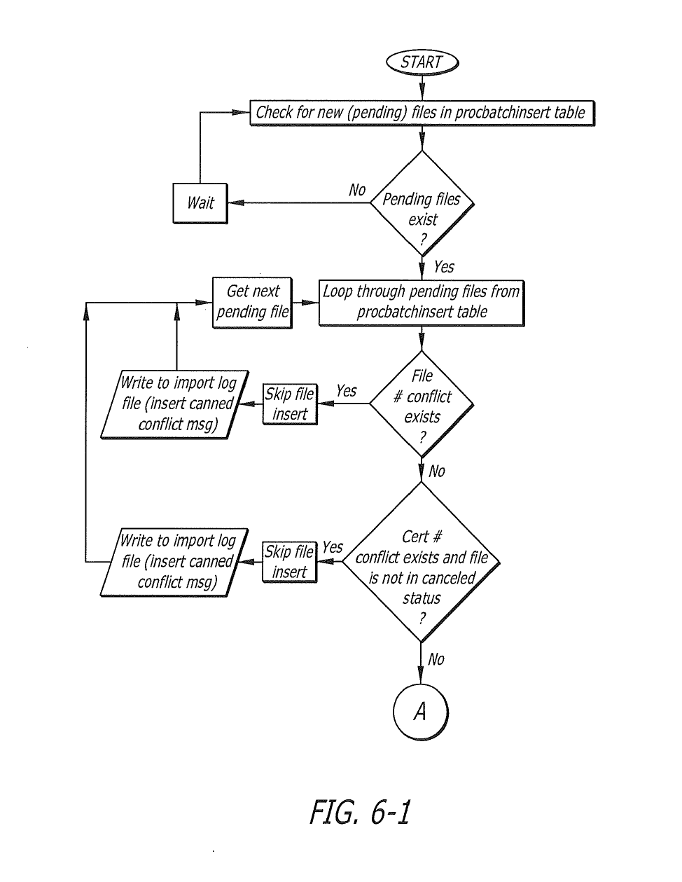

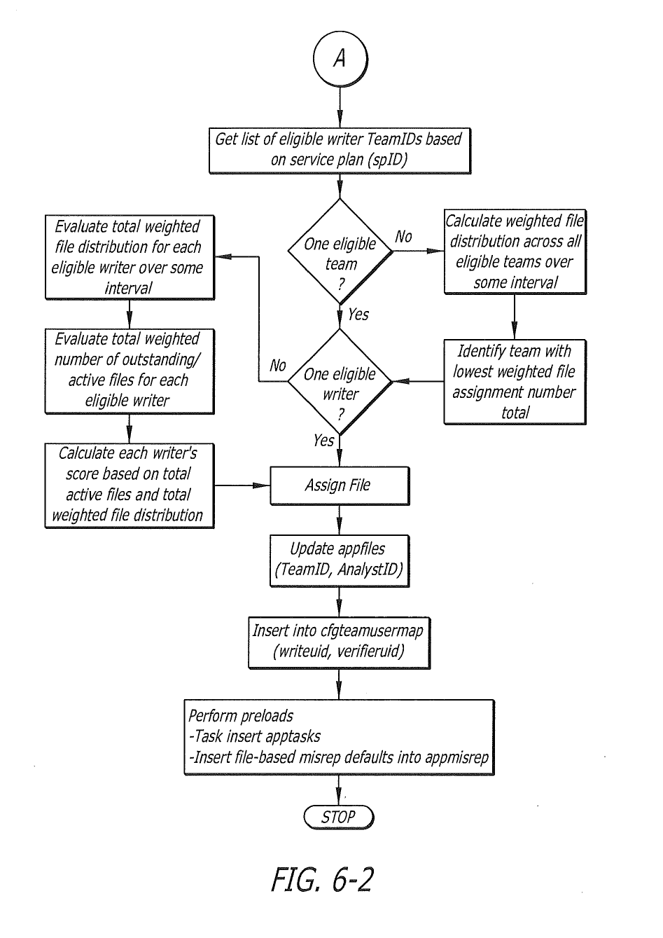

FIG. 6 illustrates an exemplary flow chart for file assignment that may be conducted prior to the process as indicated in FIG. 5 or as a sub-process to one or more of the steps identified in FIG. 5. The system may be used to determine the work load and efficiency of one or more employees/analysts to create an audit and verification team to review an incoming audit and verification request. Once the request is entered into the system, the system can review the pending work load of various employees to determine which team and/or analyst can review the new file.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm, process, and module are here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

1. (canceled)

2. An application coded to operate on a server computer system to verify information of a case file, the application comprising:
file processing logic for importing data into a database;
quality control processing logic for originating and processing information associated with the case file;
report delivery processing logic configured to generate a report from the information stored in the database.

3. The application of claim 1, wherein the file processing logic includes a user interface to permit a user to enter data into the database.

4. The application of claim 1, wherein the file processing logic is further configured to import and extract data from electronic files.

5. The application of claim 1, wherein the quality control processing logic is further configured to compare data from different sources to define a discrepancy and assign a severity to the discrepancy.

6. The application of claim 1, wherein the quality control processing logic is configured to categorize sources of information contained in the database.

7. The application of claim 6, wherein the quality control processing logic is configured to assign priorities to categories of source information.

8. The application of claim 1, wherein the database is configured to track variations of data received from alternate sources.

9. The application of claim 1, further comprising third party processing logic configured to permit a third party to supply information to the database.

10. A system for verifying info nation, the system comprising:
a database to store information relating to a transaction and an individual;
a user interface for entering and accessing information stored in the database;
quality control logic for verifying pertinent information stored in the database; and
processing logic configured for generating reports from the data stored within the database.

11. The system of claim 10, further comprising a production metrics module to track the quantity and quality of work of a user of the system.

12. The system of claim 10, further comprising a workload manager module to permit various users to access the database without conflict.

13. The system of claim 10, further comprising a metrics module to track a case file in the system and statistics associated with processing the case file.

14. The system of claim 10, wherein the quality control logic is configured to compare data from different sources and determine whether a discrepancy exists.

15. The system of claim 10 configured to run on a client-server architecture to permit multiple users access to the database simultaneously.

16. A method for verifying information, the method comprising:
entering information relating to a transaction and an individual into a database accessible from a network;
investigating the information;
entering in additional information from the investigation into the database;
analyzing the information;
creating a report including the information, results from the investigation, and conclusions of the analysis.

17. The method of claim 16, wherein the analysis is performed by an application run on a computer to determine whether discrepancies exist between the information and the additional information.

18. The method of claim 17, further comprising setting categories for a source of information and assigning a priority to the category, wherein the application assigns a risk priority to an identified discrepancy based on the source, category, and priority.

19. The method of claim 16, wherein the investigation comprises validating the information by obtaining validated information from a separate source as that of the information.

20. The method of claim 16, further comprising storing comments from an interested entity on the information and additional information into the database.

21. The method of claim 17, wherein the application generates the report presenting a single occurrence of data regardless of a quantity stored and source of data if no discrepancy exists in the data, and presenting a single occurrence of each variance if a discrepancy exists.
